(19) United States
(12) Patent Application Publication
(10) Pub. No.: US 2026/0065420 A1
(43) Pub. Date: Mar. 5, 2026

(54) IMAGE PROCESSING METHOD

(71) Applicant: Smarter Silicon (Shanghai) Technologies Co., Ltd., Shanghai (CN)

(72) Inventors: Bo ZHAO, Shanghai (CN); Zhenbo LIU, Shanghai (CN); Yubin CAO, Shanghai (CN); Zhuo YANG, Shanghai (CN)

(21) Appl. No.: 19/307,795

(22) Filed: Aug. 22, 2025

(30) Foreign Application Priority Data
Aug. 30, 2024 (CN) 202411215402.3

(51) Int. Cl. G06T 3/4053; G06T 3/4038; G06T 7/11

(52) U.S. Cl. CPC G06T 3/4053; G06T 3/4038; G06T 7/11; G06T 2207/20221

(57) ABSTRACT

An image processing method includes obtaining a target image in a video sequence, segmenting the target image into at least two regions based on feature information of the target image, performing super-resolution processing on the at least two regions using respective super-resolution processing models to obtain at least two super-resolved regions, and splicing the at least two super-resolved regions to obtain a super-resolved target image.

### CROSS-REFERENCE TO RELATED APPLICATION

This application claims priority to Chinese Patent Application No. 202411215402.3 filed on Aug. 30, 2024, the entire content of which is incorporated herein by reference.

### FIELD OF THE TECHNOLOGY

Certain embodiments of the present disclosure relate to a field of image processing, and in particular an image processing method and an electronic device.

### BACKGROUND

Computer vision (CV)-based super-resolution currently used in games has poor performance, with problems in degradation such as aliasing and blurring, which impacts the user experience. Mobile artificial intelligence (AI) methods mostly use video super-resolution, with large AI models and significant response latency, making it difficult for the AI models to achieve desirable real-time game interactions.

### SUMMARY

In accordance with the disclosure, there is provided an image processing method including obtaining a target image in a video sequence, segmenting the target image into at least two regions based on feature information of the target image, performing super-resolution processing on the at least two regions using respective super-resolution processing models to obtain at least two super-resolved regions, and splicing the at least two super-resolved regions to obtain a super-resolved target image.

Also in accordance with the disclosure, there is provided an electronic device including a memory storing instructions and a processor configured to execute the instructions to obtain a target image in a video sequence, segment the target image into at least two regions based on feature information of the target image, perform super-resolution processing on the at least two regions using respective super-resolution processing models to obtain at least two super-resolved regions, and splice the at least two super-resolved regions to obtain a super-resolved target image.

Also in accordance with the disclosure, there is provided a non-transitory computer-readable storage medium storing instructions that, when executed by a processor, cause an electronic device including the processor to obtain a target image in a video sequence, segment the target image into at least two regions based on feature information of the target image, perform super-resolution processing on the at least two regions using respective super-resolution processing models to obtain at least two super-resolved regions, and splice the at least two super-resolved regions to obtain a super-resolved target image.

### BRIEF DESCRIPTION OF THE DRAWINGS

FIG. 1 is a schematic diagram of an implementation flow of an image processing method provided in certain embodiments of the present disclosure;

FIG. 2A is a schematic diagram of an implementation flow of image segmentation provided in certain embodiments of the present disclosure;

FIG. 2B is a schematic diagram of an implementation flow of super-resolution processing provided in certain embodiments of the present disclosure;

FIG. 3A is a schematic diagram of an implementation flow of sub-region segmentation and processing provided in certain embodiments of the present disclosure;

FIG. 3B is a schematic diagram of an implementation flow of sub-region segmentation and processing provided in certain embodiments of the present disclosure;

FIG. 3C is a schematic diagram of an implementation flow of sub-region segmentation and processing provided in certain embodiments of the present disclosure;

FIG. 4 is a schematic diagram of an implementation flow of a lightweight adaptive hybrid game super-resolution algorithm provided in certain embodiments of the present disclosure;

FIG. 5 is a schematic structural diagram of an image processing device provided in certain embodiments of the present disclosure; and

FIG. 6 is a schematic structural diagram of an electronic device provided in certain embodiments of the present disclosure.

### DETAILED DESCRIPTION

To state objectives, technical solutions, and advantages of certain embodiments of the present disclosure, descriptions are provided in conjunction with the accompanying drawings. The following embodiments are described to illustrate certain features of the present disclosure and are not intended to limit the scope of the present disclosure.

When applicable, references to “certain embodiments” describe a subset of all possible embodiments. However, “certain embodiments” may refer to the same or different subsets of all possible embodiments and may be combined with each other without conflict.

When applicable, terms “first,” “second,” and “third” are used to distinguish similar objects and do not represent a particular order or sequence for the objects. The terms “first,” “second,” and “third” may be interchanged to allow certain embodiments to be implemented in an order other than the order illustrated or described.

Technical and scientific terms used in certain embodiments have the same meaning as understood by one skilled in the technical field. The terminology used in certain embodiments is for the purpose of describing certain embodiments of the present disclosure and is not intended to limit the present disclosure.

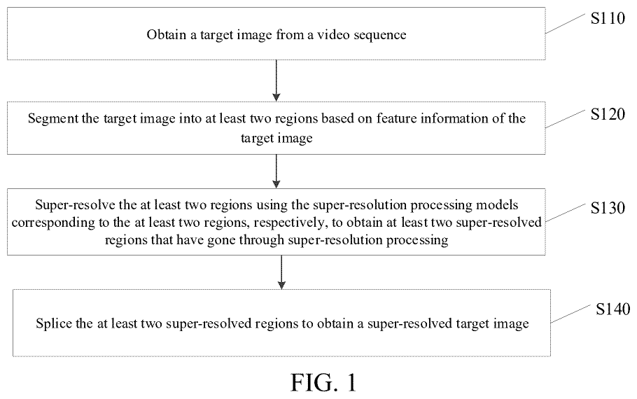

Certain embodiments of the present disclosure provide an image processing method, as shown in FIG. 1.

S110: Obtain a target image from a video sequence.

In certain embodiments, the video sequence may be a video sequence to be super-resolved (also referred to as a “target video sequence”), for example, a game video sequence to be super-resolved. In image processing, super-resolution processing (SRP) is a technique that reconstructs a high-resolution (HR) image from a low-resolution (LR) image. Lost details in the image can be inferred and restored using information in the image and preset knowledge, thereby increasing the image's clarity and level of detail.

During implementation, a frame of the target image from the video sequence to be super-resolved may be obtained.

S120: Segment the target image into at least two regions based on feature information of the target image.

During implementation, a single-layer convolution may be performed on the target image, and feature information of the target image may be determined based on the post-convolution data. The target image is then segmented into at least two regions based on the feature information. In certain embodiments, the feature information may be a human visual sensitivity feature. Human visual sensitivity features include at least spectral sensitivity, brightness perception, and resolution.

S130: Super-resolve the at least two regions using the super-resolution processing models corresponding to the at least two regions, respectively, to obtain at least two super-resolved regions that have gone through super-resolution processing.

During implementation, a super-resolution model may be selected for each region based on its feature information. Then, using the super-resolution model corresponding to each region, super-resolution may be performed on at least two regions to obtain at least two super-resolved regions. For example, a CV model may be used for super-resolution of the background region, while an AI model may be used for super-resolution of areas sensitive to the human eye.

S140: Splice the at least two super-resolved regions to obtain a super-resolved target image.

During implementation, the at least two super-resolved regions may be spliced first, and then the boundaries of the spliced adjacent regions may be fused to obtain a super-resolved target image. Image fusion integrates information from two or more regions into a single image to improve image quality, information content, and usability. The fusion result leverages the temporal and spatial correlations and information complementarity of multiple regions, resulting in a more comprehensive and clear description of the scene.

In certain embodiments of the present disclosure, a target image in a video sequence is obtained; based on the feature information of the target image, the target image is segmented into at least two regions; super-resolution processing is performed on at least two regions using a super-resolution processing model corresponding to each region to obtain at least two super-resolved regions that have gone through super-resolution processing; the at least two super-resolved regions that have gone through super-resolution processing are spliced together to obtain a super-resolved target image that has gone through super-resolution processing. Accordingly, a target image is segmented into multiple regions based on feature information, and super-resolution processing is performed according to a different super-resolution processing model corresponding to each region, thereby improving image processing efficiency. Based on feature information, models with different computational loads or processing effects are allocated according to different processing requirements. By obtaining image quality that have gone through the individualized super-resolution processing, the computational load is reduced, and power consumption and latency are reduced while keeping the image quality relatively unchanged.

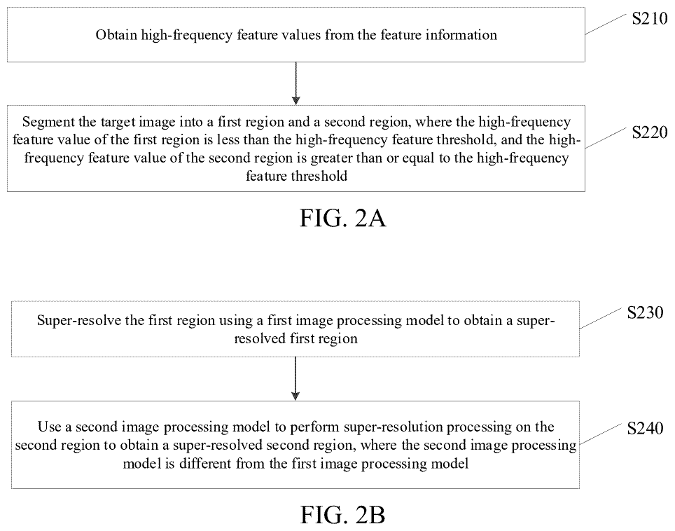

In certain embodiments, S120, “segmenting the target image into at least two regions based on the feature information of the target image,” may be implemented by the following, as shown in FIG. 2A:

S210: Obtaining high-frequency feature values from the feature information.

In certain embodiments, high-frequency features are manifested in areas where image signal intensity (brightness/grayscale) varies dramatically, for example, edges (contours) and details. High-frequency features of an image may reflect rapidly or abruptly changing information in local areas and are an important component of the image.

In certain embodiments, high-frequency features may include texture features. For example, the presence or absence of luminance texture, the presence or absence of chrominance texture, and the degree of dispersion of luminance texture and chrominance texture are all considered high-frequency features.

During implementation, a single-layer convolution operation may be performed on the target image, and the post-convolution data may be used to obtain high-frequency features.

S220: Segmenting the target image into a first region and a second region based on a preset high-frequency feature threshold and the high-frequency feature values of the target image, where the high-frequency feature value of the first region is less than the high-frequency feature threshold, and the high-frequency feature value of the second region is greater than or equal to the high-frequency feature threshold.

In certain embodiments, a preset high-frequency feature threshold TH1 may be set. Regions with high-frequency feature values less than TH1 are classified as a first region, and regions with high-frequency feature values greater than or equal to TH1 are classified as a second region.

In certain embodiments, the preset high-frequency feature threshold may be configured based on at least one of the following: power consumption, remaining battery life, and resource information of the electronic device. Thus, configuring the preset high-frequency feature threshold based on this information may reduce power consumption and conserve energy, helping ensure the battery life of the electronic device even when the remaining battery life is low or the power consumption is high.

In certain embodiments of the present disclosure, high-frequency feature values are obtained from the feature information. Based on a preset high-frequency feature threshold and the high-frequency feature values of the target image, the target image is segmented into a first region and a second region. This allows the high-frequency feature values to be used to segment the target image into two regions corresponding to different high-frequency feature values.

In certain embodiments, S130, “super-resolving the at least two regions using the super-resolution processing models corresponding to the at least two regions, respectively, to obtain the at least two super-resolved regions,” may be implemented by the following, as shown in FIG. 2B:

S230, Super-resolving the first region using a first image processing model to obtain a super-resolved first region.

In certain embodiments, the first image processing model may be a CV model. CV models include models such as Residual Networks (ResNet), Visual Geometry Group (VGG) networks, EfficientNet, and MobileNet.

In implementation, the CV model may be used to super-resolve the first region to obtain a super-resolved first region.

S240: Using a second image processing model to perform super-resolution processing on the second region to obtain a super-resolved second region, where the second image processing model is different from the first image processing model.

In certain embodiments, the second image processing model may be an AI model. Examples of AI models include Transformer models, deep generative models, and generative adversarial networks (GANs).

During implementation, the AI model may be used to super-resolve the second region to obtain a super-resolved second region.

In certain embodiments, because the high-frequency feature values of the second region are greater than those of the first region, a simpler super-resolution model with moderate super-resolution capabilities, such as a CV model, may be selected to super-resolve the first region; a more complex super-resolution model with better super-resolution capabilities, such as an AI model, may be selected to super-resolve the second region. The type super-resolution model is not limited.

In certain embodiments of the present disclosure, the first region is first super-resolved using the first image processing model to obtain the super-resolved first region; the second region is super-resolved using the second image processing model to obtain the super-resolved second region. Different models may be used to process different regions of the target image.

In certain embodiments, before the above S230 of “using the first image processing model to perform super-resolution processing on the first region to obtain the super-resolved first region,” the first image processing model and the second image processing model may be determined by the following:

S250: Based on the image optimization contribution parameters of each image processing model, the first and second image processing models are determined so that the second image quality parameters of the processed second region are superior to the first image quality parameters of the processed first region.

In certain embodiments, the image optimization contribution parameters of the image processing models play a role in improving image quality, enhancing image features, and increasing processing efficiency. During implementation, the contribution of the image processing model to optimizing image parameters during image processing may be determined based on testing of the image processing model or pre-obtained properties of the image processing model. For example, the image optimization contribution parameter may represent the image processing model's improvement rate for clarity, the image processing model's improvement rate for chroma, or the image processing model's improvement rate for saturation.

During implementation, the first and second image processing models may be determined based on the image optimization contribution parameters of the image processing models. Because the high-frequency feature values of the first region are smaller than those of the second region, meaning that the human eye is more sensitive to the second region, the image processing capabilities of the second image model selected for the second region are superior to those of the first image model selected for the first region. This allows the second image optimization parameters of the super-resolved second region to be superior to the first image optimization parameters of the super-resolved first region.

In certain embodiments of the present disclosure, the first image processing model and the second image processing model are determined based on the image optimization contribution parameters of each image processing model. This allows the second image optimization parameters of the super-resolved second region to be superior to the first image optimization parameters of the super-resolved first region.

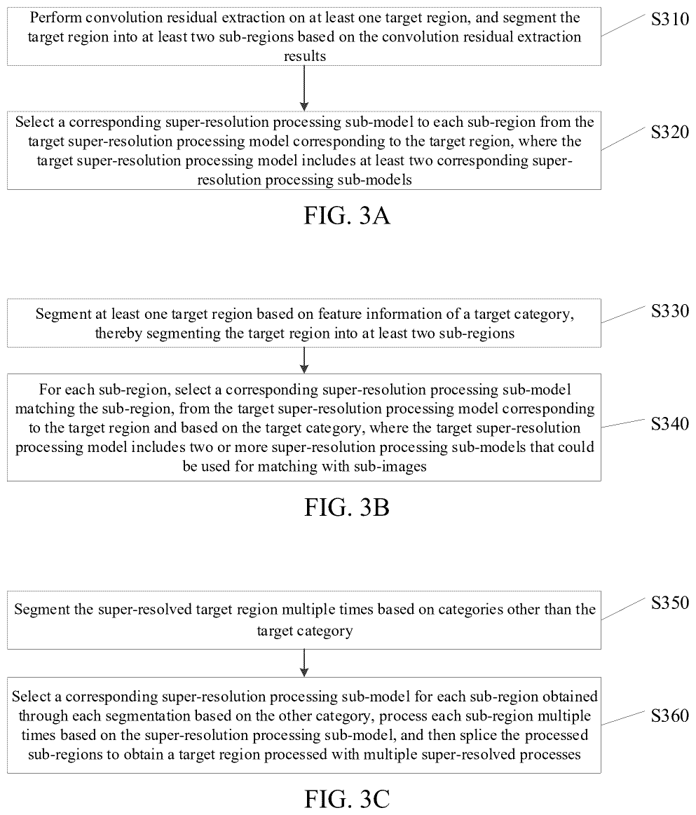

In certain embodiments, the present disclosure provides a method for segmenting and processing sub-regions, as shown in FIG. 3A, which may be implemented by the following:

S310: Perform convolution residual extraction on at least one target region, and segment the target region into at least two sub-regions based on the convolution residual extraction results.

In certain embodiments, convolution residual extraction is an image processing method in deep learning. It combines the advantages of convolutional neural networks (CNNs) and residual networks (ResNets), using residual connections to address the vanishing and exploding gradient problems in deep neural network training, thereby improving model performance.

In implementation, a target region may be processed using a single or multiple convolution residual extractions, and the target region may be segmented into at least two sub-regions based on the convolution residual extraction results. For example, a region already designated as a region corresponding to processing by an AI model may be processed using a single or multiple convolution residual extractions, to segment the region processed by the AI model into at least two sub-regions.

S320: Select a corresponding super-resolution processing sub-model for each sub-region from the target super-resolution processing model corresponding to the target region, where the target super-resolution processing model includes at least two corresponding super-resolution processing sub-models.

In certain embodiments, high-frequency feature thresholds may be used to assign model types to the first and second regions, for example, using a CV model for the first region and an AI model for the second region. A device may have multiple CV models and multiple AI models. Image optimization contribution parameters may be used to select a particular CV model, such as the Residual Network (ResNet), Visual Geometry Group (VGG) network, EfficientNet, or MobileNet. AI models include Transformer models, Deep Generative Models, and Generative Adversarial Networks (GANs).

In certain embodiments, image optimization contribution parameters may be used to select models with different parameters within the same type of CV model, such as those with different weight parameters and/or different numbers of layers within a ResNet.

For example, AI approaches analyze feature complexity after shallow convolution and use different network models for different regions, including Transformer models, Deep Generative Models, and Generative Adversarial Networks (GANs). In certain embodiments, image optimization contribution parameters may be used to select models with different parameters within the same type of AI model, such as those with different weight parameters and/or different numbers of layers within a ResNet.

The more complex the feature distribution, the larger the statistics of the feature portion, and the larger the statistics, the more complex the model. Complex models may have more layers and weight parameters than simpler models.

For example, sub-regions with high-frequency values greater than the threshold TH2 are assigned the more complex processing model a, resulting in a greater computational effort. For sub-regions with high-frequency values less than threshold TH2 and greater than TH3, processing model b is slightly simpler than model a, and the computational load of model b is less than that of model a. Model n, therefore, has the lowest computational load among the three models.

In certain embodiments, convolution residual extraction is performed on at least one target region, and based on the convolution residual extraction results, the target region is segmented into at least two sub-regions. Then, a corresponding super-resolution processing sub-model is selected for each sub-region from the target super-resolution processing model corresponding to the target region. This allows for further segmentation of the target region and selection of super-resolution processing sub-models to different sub-regions, improving image processing efficiency. This avoids subjecting all pixels in the target region to participate in complex network calculations, reducing computational load while maintaining image quality while reducing power consumption and latency.

In certain embodiments, S310, “performing convolution residual extraction on at least one target region to segment the target region into at least two sub-regions based on the convolution residual extraction result,” may be implemented by the following:

311: Performing convolution residual extraction on the at least one target region to obtain a feature proportion distribution for the target region.

In certain embodiments, feature proportion distribution refers to the distribution ratio of each feature value or feature category in a dataset.

In implementation, convolution residual extraction may be performed on the at least one target region to obtain a feature proportion distribution for the target region. Based on this feature proportion distribution, the target region may be segmented and a suitable network model may be selected for the resulting sub-regions.

For example, when the feature is a brightness feature, the distribution ratio of each brightness feature value in the brightness feature dataset may be determined. When the image brightness value range is 0 to 255, the distribution of brightness values in the image, for example, from 0 to 255, may be determined. Based on this distribution of brightness values from 0 to 255, the target region may be segmented and a suitable network model may be selected for the resulting sub-regions.

312: Segment the target region into at least two sub-regions based on the feature proportion distribution.

During implementation, the target region may be segmented based on feature proportion. For example, pixels concentrated in a certain feature value may be grouped into a sub-region, or pixels of the same feature category may be grouped into a sub-region.

In certain embodiments, the target region may also be a region designated for use with a CV model. A single or multiple convolutional residual extractions may be performed on the region already designated for CV model processing to obtain a feature distribution within the region. The region processed by the CV model is then segmented into at least two sub-regions based on this feature distribution. CV models include Residual Networks (ResNet), Visual Geometry Group (VGG) networks, EfficientNet, and MobileNet.

In certain embodiments, convolutional residual extraction is performed on at least one target region to obtain a feature distribution within the target region. The target region is then segmented into at least two sub-regions based on this feature distribution. This allows the target region to be segmented into at least two sub-regions using the feature distribution within the target region.

Certain embodiments provide a method for segmenting and processing sub-regions, as shown in FIG. 3B, including the following:

S330: Segment at least one target region based on feature information of a target category, thereby segmenting the target region into at least two sub-regions.

In certain embodiments, the target category may be either temporal or spatial. Spatial attributes may be used to examine feature strength, discreteness, structural integrity, and feature richness; temporal attributes may be used to examine the number of moving features, the intensity of motion, disappearing feature points, newly added feature points, translational motion, curvilinear motion, and so on.

During implementation, the target region may be segmented based on temporal features or spatial features. For example, temporal features may be obtained and then the target region may be segmented into multiple sub-regions based on the temporal features.

S340: For each sub-region, select a corresponding super-resolution processing sub-model matching the sub-region, from the target super-resolution processing model corresponding to the target region and based on the target category, where the target super-resolution processing model includes two or more super-resolution processing sub-models that could be used for matching with sub-images.

During implementation, a corresponding super-resolution processing sub-model may be selected for each sub-region within the obtained target super-resolution processing model corresponding to the target region based on spatial or temporal features. For example, a corresponding AI processing sub-model may be selected for each sub-region within the AI processing model corresponding to the target region based on spatial or temporal features.

Correspondingly, S130, “performing super-resolution processing on the at least two regions using the super-resolution processing model corresponding to each region to obtain at least two super-resolved regions,” may be implemented by the following:

131, processing each sub-region using the super-resolution processing sub-model corresponding to the sub-region to obtain each super-resolved sub-region.

For example, each sub-region may be processed using the AI processing sub-model corresponding to the sub-region.

132, splicing the processed sub-regions to obtain the super-resolved target region.

In certain embodiments of the present disclosure, at least one target region is segmented based on the feature information of the target category to segment the target region into at least two or more sub-regions; from the target super-resolution processing model corresponding to the target region, a corresponding super-resolution processing sub-model is selected for each sub-region based on the target category; each sub-region is processed using the super-resolution processing sub-model selected for each sub-region to obtain each sub-region that has been processed; and each sub-region that has been processed is spliced together to obtain a target region that has been super-resolved. It is possible to segment the target region based on the feature information of the target category, then process each sub-region based on the super-resolution processing sub-model that corresponds to the target category to obtain each sub-region, and then splice each sub-region that has been processed to obtain a target region that has been super-resolved.

The target category may include multiple categories. Certain embodiments of the present disclosure provide a method for segmenting and processing sub-regions, as shown in FIG. 3C, which may be implemented by the following:

S350: Segment the super-resolved target region multiple times based on categories other than the target category.

In certain embodiments, the target category and other categories include at least one of the following categories: color features, texture features, shape features, spatial features, temporal features, or the like.

During implementation, the target category may be determined to be a spatial feature. The target region is segmented based on the spatial feature and assigned with the super-resolution processing sub-model to obtain a target region processed with the spatial feature. The target region processed with the spatial feature is then segmented based on the color feature and assigned with the super-resolution processing sub-model to obtain the sub-regions, and so on, thus segmenting the target region based on multiple categories.

S360: Select a corresponding super-resolution processing sub-model for each sub-region obtained through each segmentation based on the other category, process each sub-region multiple times based on the super-resolution processing sub-model, and then splice the processed sub-regions to obtain a target region processed with multiple super-resolved processes (also referred to as a “multi-super-resolved target region”).

In certain embodiments, multiple segmentation may be performed based on feature categories such as color, texture, shape, spatial, and temporal. For example, sub-regions may be segmented based on spatial features, processed with corresponding models, and then processed based on temporal features and selected models. Accordingly, a particular region in the target image may be processed by a number of models, and the results are spliced or merged.

In certain embodiments, the super-resolved target region is segmented based on categories other than the target category. Then, a corresponding super-resolution processing sub-model is selected for each sub-region obtained from each segmentation based on the other categories. This allows each sub-region to be processed multiple times using super-resolution processing sub-models selected for different categories, and the processed sub-regions are then spliced to obtain the target region that has undergone multiple super-resolved processes.

Certain embodiments of the present disclosure provide a method for segmenting and processing sub-regions, which is similar to that shown in FIG. 3B. This method may be implemented by the following:

S370: Segment at least one target region based on feature information of target motion, thereby segmenting the target region into at least two or more sub-regions.

In certain embodiments, the motion feature information refers to the positional change of pixels between two consecutive frames in a video. During implementation, the motion information may be provided by the game manufacturer or obtained based on adjacent frames in the video.

During implementation, the target region may be segmented based on the obtained feature information of target motion.

S380: For each sub-region, select a corresponding super-resolution processing sub-model matching the sub-region, from the target super-resolution processing model corresponding to the target region and based on the target motion. The target super-resolution processing model may include two or more corresponding super-resolution processing sub-models.

During implementation, a super-resolution processing sub-model may be selected for each sub-region based on the target motion. For example, a super-resolution processing sub-model may be determined based on different motion parameters such as speed, direction, and shape. The super-resolution processing sub-model is used to process the corresponding sub-region.

In certain embodiments of the present disclosure, at least one target region is segmented based on the feature information of target motion to form at least two or more sub-regions of the target region. Then, a corresponding super-resolution processing sub-model is selected for each sub-region based on the target motion from the target super-resolution processing model corresponding to the target region. Accordingly, the target region may be segmented based on the feature information of motion, and then each sub-region may be obtained by selecting the corresponding super-resolution processing sub-model based on the feature information of motion.

In certain embodiments, the image processing method may include the following:

S150: Determine, based on the motion information of each region, that the target region has the same location data at the same location in the previous frame of the target region.

During implementation, the target region may be determined to have the same location data at the same location in the previous frame of the target region based on the positional changes of pixels between the previous and next frames of the video, for example, the motion information, for example, the data in the target region in the previous and next frames is identical and static. For example, the target region may be determined to be a background region that has not changed between the previous and next frames.

S160: Reuse the processed data at the same location in the previous frame as the processed target region data.

During implementation, the scene content changes between the previous and next frames may be determined, and a combination of replacement and processing may be used. In the case of static or smooth regions, for example, where the content between the previous and next frames has not changed, the content of the previous frame's super-resolution result may be directly used to fill the corresponding position in the current frame without performing super-resolution operations, or the weights of the previous frame may be directly shared. In certain embodiments, weights may refer to the model weights used for super-resolution of the previous frame, for example, a series of parameters trained for super-resolution.

In certain embodiments of the present disclosure, based on the motion information of each region, the target region is determined to be identical to in location data at the same location in the previous frame of the target region; then, the data for the region at the same location in the previous frame of the processed image is reused as the processed target region data. Accordingly, when the target region is determined to be a stationary or smooth region, reusing the processed target region data from the previous frame may reduce processing energy consumption, thus improve processing efficiency without affecting the processing effect.

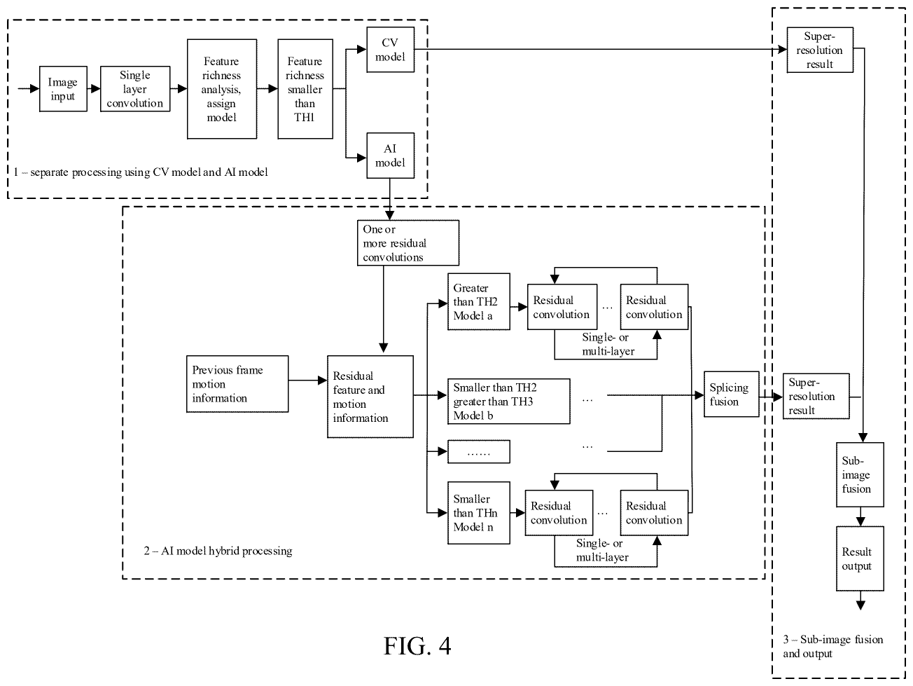

FIG. 4 is a flow chart of a lightweight adaptive hybrid game super-resolution algorithm provided by certain embodiments of the present disclosure. As shown in FIG. 4, the algorithm may be implemented through the following:

### 1: Separate Processing Using CV Model and AI Model.

During implementation, a low-resolution image and a high-resolution image, along with corresponding depth and motion information, may be rendered in the game. In games, depth information refers to the distance between objects and the camera and the image distribution hierarchy when the acquisition device captures the image. Motion information refers to the change in pixel position between two frames. Depth information may be provided by the game manufacturer for rendering. Motion information may be provided by the game manufacturer (and may be calculated in the video) for inter-frame processing.

A single-layer convolution is performed on the input game image. The post-convolution data is used to analyze high-frequency information (texture features), such as the richness and dispersion of brightness and chroma (not limited to these two attributes). A threshold TH1 is set to segment different regions. Examples of the two attributes for high-frequency information include the abundance or absence of brightness texture, the abundance or absence of chroma texture, and the dispersion of brightness texture and chroma texture. Other attributes may be selected, as long as they may distinguish high-frequency information (texture features), such as the structural properties of image textures or their frequency domain distribution. This method encompasses any method that may distinguish the distribution of texture features.

Based on the analyzed data, the super-resolution process assesses the contribution of image quality. For example, visual resolution is used as a criterion, and an appropriate game super-resolution method is adaptively selected. For example, when the feature is less than TH1, a CV model is used, and when the feature is greater than or equal to TH1, an AI model is used. This method is applicable not only to game super-resolution but also to video super-resolution. In certain embodiments, contribution refers to the degree of impact on image quality, and may also be understood as the degree to which different processing methods may improve image quality. For example, different processing methods may result in different visual discernibility (clarity) of the image. Different processing methods may result in different clarity (brightness and chroma), with higher image quality indicating a greater contribution. Features may represent the distribution of image content, while contribution refers to the degree to which image textures may be discerned.

### 2: AI Model Hybrid Processing.

During implementation, AI is used to analyze feature complexity after shallow convolution to apply different network models to different regions. For example, the distribution of feature proportions (TH2, TH3, . . . , THn) extracted from the residuals of single or multi-layer convolutions may be used to determine whether different network models are suitable. Further divisions may be performed based on different pattern attributes (not limited to pattern attributes) of the features, thereby forming a hybrid of multiple models. Feature proportion distribution refers to the distribution ratio of each feature value or feature category in a dataset. For example, when the feature is brightness, the distribution ratio of each brightness feature value in the brightness feature dataset may be determined. When the image brightness ranges from 0 to 255, the distribution of brightness values from 0 to 255 in the image may be determined. Based on this distribution of brightness values from 0 to 255, the corresponding network model for classification is determined.

In certain embodiments, a feature is a calculated value that measures the distribution of features in a region and is compared against one or more thresholds. Complex models may have more layers and weight parameters than simpler models. The more complex the feature distribution, the larger the statistics of the feature part, and the larger the statistics. For processing sub-regions with high-frequency values less than the threshold TH2 and greater than TH3, model b is simpler than model a. The computational load of model b is also smaller than that of model a, . . . , and model n has the lowest complexity and the lowest computational load.

As shown in FIG. 4, after models a through n process the image, the AI-based results from multiple models or multiple types of models are spliced and fused, including weight sharing and compression.

In certain embodiments, a combination of replacement and processing may be used to determine changes in scene content between previous and next frames. In static or smooth areas, where the content between previous and next frames remains unchanged, the super-resolution result of the previous frame is used to fill the corresponding position in the current frame without performing super-resolution operations or sharing the weights of the previous frame.

In certain embodiments, different threshold parameters may be adjusted based on the battery level of the electronic device to control the super-resolution method and thus power consumption. For example, TH1, TH2, TH3, . . . , THn are different thresholds, which are pre-set. Different coefficients w are applied based on the battery level of the electronic device. When the battery level drops below a certain value (to ensure battery life), the coefficients w gradually increase (for example, the value of w gradually increases, and the threshold values are adjusted using the coefficients w: TH1*w, TH2*w, . . . , THn*w). Larger thresholds reduce the area that may be processed using more complex models, thus saving power. For example, a larger TH1 value reduces the area of the same image that may be processed using the AI model, while a larger area may be processed using the CV model, thus saving power.

### 3: Sub-Image Fusion and Output.

During implementation, after super-resolution processing of different regions using the CV model and the AI model, the resulting super-resolution sub-images are spliced and fused, and the result is output.

In certain embodiments, based on the human visual sensitivity, statistical analysis of scene content is performed based on different attributes. This method is not limited to a single method or category; any method that may perform statistical analysis of scene content attributes may be implemented. Based on the statistical results, methods of varying complexity are adaptively adopted, such as CV and AI network models. Different network models are also used based on the different attributes being calculated, for super-resolution processing. Algorithms are used according to the complexity of the scene content: Focusing on processing feature information sensitive to the human eye, models with corresponding computational effort are used based on feature complexity. Regions with complex features have a larger receptive field and deeper residual layers to extract higher-level features. Regions with simpler features have a smaller receptive field and fewer residual layers. Different levels or types of network models are used based on varying feature complexity. Game information is used to process motion, selecting network models of varying complexity based on the motion of previous and next frames and the feature complexity. The results of the various models are compressed, spliced, and fused. This method, in certain embodiments, eliminates the need for all pixels in a scene to participate in complex network calculations, reducing the portion of scene content that may require AI models to process to approximately 8%. Furthermore, by adjusting thresholds based on the desired end result, the amount of computation required by the AI model is controlled, reducing the computational load while maintaining image quality and reducing power consumption and latency. Image quality and computational load may be manually or automatically adjusted based on different scenes and the battery level.

In certain embodiments, the present disclosure provides an image processing device. The device includes various modules, each of which includes various submodules. These modules may be implemented by a processor in an electronic device; however, they may be implemented by a logic circuit. During implementation, the processor may be a central processing unit (CPU), a microprocessor (MPU), a digital signal processor (DSP), or a field programmable gate array (FPGA).

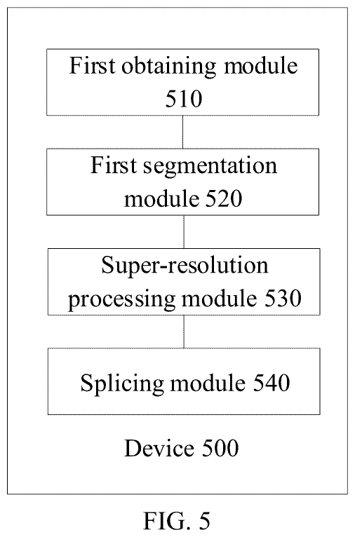

FIG. 5 is a schematic structural diagram of the image processing device provided in certain embodiments of the present disclosure. As shown in FIG. 5, the device 500 includes:
A first obtaining module 510 for obtaining a target image from a video sequence;
A first segmentation module 520 for segmenting the target image into at least two regions based on feature information of the target image;
A super-resolution processing module 530 for super-resolving the at least two regions using a super-resolution processing model corresponding to each region to obtain at least two super-resolved regions;
A splicing module 540 for splicing the at least two super-resolved regions to obtain a super-resolved target image.

In certain embodiments, the first segmentation module 520 includes a first obtaining submodule and a first segmentation submodule, where the first obtaining submodule is used to obtain the high-frequency feature value in the feature information; the first segmentation submodule is used to segment or segment the target image into a first region and a second region based on a preset high-frequency feature threshold and the high-frequency feature value of the target image, where the high-frequency feature value of the first region is less than the high-frequency feature threshold, and the high-frequency feature value of the second region is greater than or equal to the high-frequency feature threshold.

In certain embodiments, the super-resolution processing module 530 includes a first super-resolution processing submodule and a second super-resolution processing submodule. The first super-resolution processing submodule is configured to super-resolve the first region using a first image processing model to obtain a processed first region. The second super-resolution processing submodule is configured to super-resolve the second region using a second image processing model to obtain a processed second region. The second image processing model is different from the first image processing model.

In certain embodiments, the super-resolution processing module 530 further includes a determination submodule configured to determine the first and second image processing models based on image optimization contribution parameters of the respective image processing models, such that the second image quality parameters of the processed second region are superior to the first image quality parameters of the processed first region.

In certain embodiments, the image processing method further includes a convolutional residual extraction module and a first matching module. The convolutional residual extraction module is configured to perform convolutional residual extraction on at least one target region to segment the target region into at least two sub-regions based on the convolutional residual extraction results. The first selection module is configured to select a corresponding super-resolution processing sub-model to each sub-region from a target super-resolution processing model corresponding to the target region, where the target super-resolution processing model includes at least two selectable super-resolution processing sub-models.

In certain embodiments, the convolutional residual extraction module includes a convolutional residual extraction sub-module and a second segmentation sub-module. The convolutional residual extraction sub-module is configured to perform convolutional residual extraction on the at least one target region to obtain a feature proportion distribution of the target region. The second segmentation sub-module is configured to segment the target region into the at least two sub-regions based on the feature proportion distribution.

In certain embodiments, the image processing module further includes a second segmentation module and a second selection module. The second segmentation module is configured to segment at least one target region based on feature information of the target category, thereby segmenting the target region into at least two or more sub-regions. The second selection module is configured to select a corresponding super-resolution processing sub-model for each sub-region based on the target category from the target super-resolution processing model corresponding to the target region, where the target super-resolution processing model includes two or more super-resolution processing sub-models. In certain embodiments, the super-resolution processing module 530 includes a processing sub-module and a splicing sub-module. The processing sub-module is configured to process each sub-region using the super-resolution processing sub-model selected for each sub-region to obtain each processed sub-region. The splicing sub-module is configured to splice each processed sub-region to obtain a super-resolved target region.

In certain embodiments, the target category includes multiple categories, and the image processing module also includes a third segmentation module and a third selection module, where the third segmentation module is used to segment the target region that has gone through the super-resolution processing based on one or more categories other than the target category; the third selection module is used to select the corresponding super-resolution processing sub-model for each sub-region obtained for each segmentation based on the other categories, so as to process each sub-region based on the super-resolution processing sub-model, and splice each sub-region that has gone through the processing to obtain the target region that has gone through the super-resolution processing.

In certain embodiments, the image processing module further includes a fourth segmentation module and a fourth selection module. The fourth segmentation module is configured to segment at least one target region into at least two sub-regions based on feature information of target motion. The fourth selection module is configured to select a corresponding super-resolution processing sub-model for each sub-region based on the target motion from the target super-resolution processing model corresponding to the target region. The target super-resolution processing model includes two or more super-resolution processing sub-models.

In certain embodiments, the image processing module further includes a determination module and a copy module. The determination module is configured to determine, based on the motion information of each region, whether the target region is identical to the region data at the same location in the previous frame of the target region. The copy module is configured to copy or repeat or reproduce the processed region data at the same location in the previous frame of the target region as the processed target region data.

The description of the device embodiments is similar to the description of the method embodiments and has similar beneficial effects as the method embodiments. For technical details not disclosed in the device embodiments, relevant description of the method embodiments may be referred to for understanding.

In certain embodiments of the present disclosure, when the method is implemented in the form of a software function module and sold or used as an independent product, the method may be stored in a computer-readable storage medium. The technical solution of certain embodiments of the present disclosure may be embodied in the form of a software product. The computer software product is stored in a storage medium and includes several instructions for enabling an electronic device (which may be a mobile phone, tablet computer, laptop computer, desktop computer, or the like) to execute all or part of the method. The storage medium includes various media that may store program code, such as a USB flash drive, a mobile hard disk, a read-only memory (ROM), a magnetic disk, or an optical disk. Certain embodiments of the present disclosure are not limited to any particular combination of hardware and software.

Certain embodiments of the present disclosure provide a storage medium having a computer program stored thereon. When executed by a processor, the computer program implements the image processing method provided in certain embodiments.

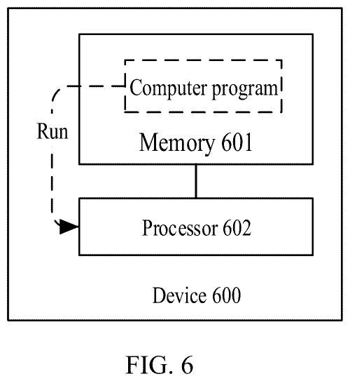

Certain embodiments of the present disclosure provide an electronic device. FIG. 6 is a schematic structural diagram of the electronic device provided in certain embodiments of the present disclosure. As shown in FIG. 6, the electronic device 600 includes a memory 601 and a processor 602. The memory 601 stores a computer program executable by the processor 602. When the processor 602 executes the computer program, the processor 602 implements the image processing method.

The memory 601 is configured to store instructions executable by the processor 602 and may cache data to be processed or processed by the processor 602 and various modules in the electronic device 600 (for example, image data, audio data, voice communication data, and video communication data). This may be implemented using flash memory (FLASH) or random access memory (RAM).

The description of the above storage medium and device embodiments is similar to the description of the above-mentioned method embodiments and has similar beneficial effects as the method embodiments. For technical details not disclosed in the storage medium and device embodiments of this application, please refer to the description of the method embodiments of this application for an understanding.

When applicable, terms such as “an embodiment” or “one embodiment” or “certain embodiments” refer to that features, structures, or characteristics associated with certain embodiments. Therefore, the appearance of “in one embodiment” or “in certain embodiments” does not necessarily refer to the same embodiment. Furthermore, these features, structures, or characteristics may be combined in any suitable manner. The order of execution of the method does not necessarily indicate a particular order of execution. The order of execution of each process is determined by its function and logic and does not constitute any limitation on the implementation of certain embodiments of the present disclosure. The above-mentioned numbers of certain embodiments are for descriptive purposes only and do not represent the superiority or inferiority of certain embodiments.

When applicable, terms “comprise” and “include” and any other variations thereof are intended to encompass non-exclusive inclusion, such that a process, method, device, or apparatus includes not only included elements but also other elements not explicitly listed in such process, method, device, or apparatus. An element mentioned by the phrase “comprises a . . . ” does not preclude the presence of additional elements in the process, method, device, or apparatus.

The disclosed devices and methods may be implemented in other ways. The device embodiments described are illustrative. For example, the division of units described is a logical functional division. In implementations, other divisions may be employed, such as combining multiple units or components, integrating them into another system, or omitting or not implementing certain features. Furthermore, the coupling, direct coupling, or communication connection between the components shown or discussed may be through interfaces, or indirect coupling or communication connection between devices or units may be electrical, mechanical, or other forms.

The units described as separate components may or may not be physically separate, and the components shown as units may or may not be physical units. They may be located in a single location or distributed across multiple network units. Some or all of these units may be selected to achieve the objectives of certain embodiments.

The functional units in certain embodiments of the present disclosure may be integrated into a single processing unit, each unit may be independently configured as a unit, or two or more units may be integrated into a single unit. These integrated units may be implemented in hardware or as hardware plus software functional units.

All or part of the method embodiments may be performed by hardware associated with program instructions. The program may be stored in a computer-readable storage medium, which, when executed, performs the method embodiments. Such storage medium includes various media capable of storing program code, such as removable storage devices, read-only memories (ROMs), magnetic disks, or optical disks.

In certain embodiments, when the integrated units are implemented as software functional modules and sold or used as standalone products, they may also be stored in a computer-readable storage medium. The technical solutions of certain embodiments may be embodied in the form of a software product. This computer software product, stored in a storage medium, includes instructions for enabling an electronic device (such as a mobile phone, tablet, laptop, or desktop computer) to execute all or part of the method embodiments. The storage medium includes various media capable of storing program code, such as a mobile storage device, ROM, magnetic disk, or optical disk.

The methods disclosed in certain embodiments may be combined in any suitable way, unless they conflict with each other, to produce new method embodiments.

The features disclosed in certain embodiments may be combined in any suitable way, unless they conflict with each other, to produce new product embodiments.

The features disclosed in certain embodiments may be may be combined in any suitable way, unless they conflict with each other, to produce new method or device embodiments.

The scope of protection of the present disclosure is not limited to the embodiments described herein. Any modifications or substitutions that may be readily conceived by a person skilled in the technical field are covered by the scope of protection of the present disclosure. The scope of protection of the present disclosure is based on the scope of protection of the claims.

What is claimed is:

1. An image processing method comprising:
obtaining a target image in a video sequence;
segmenting the target image into at least two regions based on feature information of the target image;
performing super-resolution processing on the at least two regions using respective super-resolution processing models, to obtain at least two super-resolved regions; and
splicing the at least two super-resolved regions to obtain a super-resolved target image.

2. The method of claim 1, wherein segmenting the target image includes:
obtaining high-frequency feature values from the feature information; and
segmenting the target image into a first region and a second region based on a high-frequency feature threshold and the high-frequency feature values, a high-frequency feature value of the first region being less than the high-frequency feature threshold, and a high-frequency feature value of the second region being greater than or equal to the high-frequency feature threshold.

3. The method of claim 2, wherein performing super-resolution processing on the at least two regions includes:
performing super-resolution processing on the first region using a first image processing model to obtain a processed first region; and
performing super-resolution processing on the second region using a second image processing model different from the first image processing model to obtain a processed second region.

4. The method of claim 3, further comprising:
determining the first image processing model and the second image processing model based on image optimization contribution parameters of respective image processing models, such that a second image quality parameter of the processed second region is superior to a first image quality parameter of the processed first region.

5. The method of claim 1, further comprising, for a target region among the at least two regions:
performing convolution residual extraction on the target region to segment the target region into at least two sub-regions based on a convolution residual extraction result; and
for each sub-region of the at least two sub-regions, selecting a corresponding super-resolution processing sub-model for the sub-region from two or more super-resolution processing sub-models in a target super-resolution processing model corresponding to the target region.

6. The method of claim 5, wherein performing convolution residual extraction on the target region to segment the target region into the at least two sub-regions based on the convolution residual extraction result includes:
performing convolution residual extraction on the target region to obtain a feature proportion distribution of the target region; and
segmenting the target region into the at least two sub-regions based on the feature proportion distribution.

7. The method of claim 1, further comprising:
segmenting a target region among the at least two regions into at least two sub-regions based on feature information of a target category; and
for each sub-region of the at least two sub-regions, selecting a corresponding super-resolution processing sub-model for the sub-region from two or more super-resolution processing sub-models in a target super-resolution processing model corresponding to the target region based on the target category;
wherein performing super-resolution processing on the at least two regions includes, for the target region:
performing super-resolution processing on the at least two sub-regions using the super-resolution processing sub-models corresponding to the at least two sub-regions, respectively, to obtain processed sub-regions; and
splicing the processed sub-regions to obtain a super-resolved target region.

8. The method of claim 7,
wherein the at least two sub-regions are at least two first sub-regions, the processed sub-regions are first processed sub-regions, and the target category is a first category;
the method further comprising:
segmenting the super-resolved target region based on a second category different from the first category to obtain at least two second sub-regions;
performing super-resolution processing on the at least two second sub-regions using super-resolution processing sub-models selected for the at least two second sub-regions, respectively, based on the second category, to obtain second processed sub-regions; and
splicing the second processed sub-regions to obtain a multi-super-resolved target region.

9. The method of claim 1, further comprising:
segmenting a target region among the at least two regions into at least two sub-regions based on feature information of target motion; and
for each sub-region of the at least two sub-regions, selecting a corresponding super-resolution processing sub-model for the sub-region from two or more super-resolution processing sub-models in a target super-resolution processing model corresponding to the target region based on the target motion.

10. The method of claim 1, further comprising:
determining, based on motion information of each of the at least two regions, that data of a target region is same as data of a region of a previous image frame at a same location as the target region; and
reusing processed data of the region of the previous image frame at the same location as processed data of the target region.

11. An electronic device comprising:
a memory storing instructions; and
a processor configured to execute the instructions to:
obtain a target image in a video sequence;
segment the target image into at least two regions based on feature information of the target image;
perform super-resolution processing on the at least two regions using respective super-resolution processing models, to obtain at least two super-resolved regions; and
splice the at least two super-resolved regions to obtain a super-resolved target image.

12. The electronic device of claim 11, wherein the processor is further configured to execute the instructions to, when segmenting the target image:
obtain high-frequency feature values from the feature information; and
segment the target image into a first region and a second region based on a high-frequency feature threshold and the high-frequency feature values, a high-frequency feature value of the first region being less than the high-frequency feature threshold, and a high-frequency feature value of the second region being greater than or equal to the high-frequency feature threshold.

13. The electronic device of claim 12, wherein the processor is further configured to execute the instructions to, when performing super-resolution processing on the at least two regions:
perform super-resolution processing on the first region using a first image processing model to obtain a processed first region; and
perform super-resolution processing on the second region using a second image processing model different from the first image processing model to obtain a processed second region.

14. The electronic device of claim 13, wherein the processor is further configured to execute the instructions to:
determine the first image processing model and the second image processing model based on image optimization contribution parameters of respective image processing models, such that a second image quality parameter of the processed second region is superior to a first image quality parameter of the processed first region.

15. The electronic device of claim 11, wherein the processor is further configured to execute the instructions to, for a target region among the at least two regions:
perform convolution residual extraction on the target region to segment the target region into at least two sub-regions based on a convolution residual extraction result; and
for each sub-region of the at least two sub-regions, select a corresponding super-resolution processing sub-model for the sub-region from two or more super-resolution processing sub-models in a target super-resolution processing model corresponding to the target region.

16. The electronic device of claim 15, wherein the processor is further configured to execute the instructions to, when performing convolution residual extraction on the target region to segment the target region into the at least two sub-regions based on the convolution residual extraction result:
perform convolution residual extraction on the target region to obtain a feature proportion distribution of the target region; and
segment the target region into the at least two sub-regions based on the feature proportion distribution.

17. The electronic device of claim 11, wherein the processor is further configured to execute the instructions to:
segment a target region among the at least two regions into at least two sub-regions based on feature information of a target category;
for each sub-region of the at least two sub-regions, select a corresponding super-resolution processing sub-model for the sub-region from two or more super-resolution processing sub-models in a target super-resolution processing model corresponding to the target region based on the target category; and
when performing super-resolution processing on the at least two regions, for the target region:
perform super-resolution processing on the at least two sub-regions using the super-resolution processing sub-models corresponding to the at least two sub-regions, respectively, to obtain processed sub-regions; and
splice the processed sub-regions to obtain a super-resolved target region.

18. The electronic device of claim 17, wherein:
the at least two sub-regions are at least two first sub-regions, the processed sub-regions are first processed sub-regions, and the target category is a first category; and
the processor is further configured to execute the instructions to:
segment the super-resolved target region based on a second category different from the first category to obtain at least two second sub-regions;
perform super-resolution processing on the at least two second sub-regions using super-resolution processing sub-models selected for the at least two second sub-regions, respectively, based on the second category, to obtain second processed sub-regions; and
splice the second processed sub-regions to obtain a multi-super-resolved target region.

19. The electronic device of claim 11, wherein the processor is further configured to execute the instructions to:
segment a target region among the at least two regions into at least two sub-regions based on feature information of target motion; and
for each sub-region of the at least two sub-regions, select a corresponding super-resolution processing sub-model for the sub-region from two or more super-resolution processing sub-models in a target super-resolution processing model corresponding to the target region based on the target motion.

20. A non-transitory computer-readable storage medium storing instructions that, when executed by a processor, cause an electronic device including the processor to obtain a target image in a video sequence, segment the target image into at least two regions based on feature information of the target image, perform super-resolution processing on the at least two regions using respective super-resolution processing models to obtain at least two super-resolved regions, and splice the at least two super-resolved regions to obtain a super-resolved target image.
